(19) United States
(12) Patent Application Publication
(10) Pub. No.: US 2026/0127959 A1
(43) Pub. Date: May 7, 2026

(54) SYSTEM AND METHOD FOR DOCUMENTING VEHICULAR EVENTS

(71) Applicant: GM GLOBAL TECHNOLOGY OPERATIONS LLC, Detroit, MI (US)

(72) Inventors: Mohammad Naserian, Windsor (CA); Daniel Xie, Markham (CA); Utkarsh Saini, Pickering (CA); Patrick Giancarlo Gabriel DiGioacchino, Niagara Falls (CA)

(73) Assignee: GM GLOBAL TECHNOLOGY OPERATIONS LLC, Detroit, MI (US)

(21) Appl. No.: 18/939,691

(22) Filed: Nov. 7, 2024

(51) Int. Cl. G08G 1/01

(52) U.S. Cl. CPC G08G 1/0133; G08G 1/0141

(57) ABSTRACT

Methods and apparatus are provided for matching vehicles related to a collision event involving a first vehicle and a second vehicle. A first collision message having data related to a first collision event detected by the first vehicle with a first unknown vehicle is received by a collision matching application. The collision matching application determines whether a second collision message having data related to a second collision event detected by the second vehicle with a second unknown vehicle has been received. The first and second collision messages are compared to determine whether the first collision event is the same as the second collision event. A first collision report is transmitted to the first vehicle and a second collision report to the second vehicle after determining that the first collision event is the same as the second collision event.

### INTRODUCTION

The technical field generally relates to gathering and documenting data associated with vehicular collision events, and more particularly relates to a system and method for generating a collision report for a multi-vehicle collision event.

In recent years, advancements in vehicular safety technologies have increasingly focused on improving the ability of vehicles to prevent and mitigate collisions. One significant area of development is in vehicular communication protocols, which allow vehicles to exchange critical information in real time. These systems are designed to enhance situational awareness, enabling vehicles to react to potential hazards before they become imminent threats. A primary use case for vehicular communication is the transmission of vehicle data to cloud-based applications, hosted on a remote server.

In the event of a minor collision event, drivers of vehicles involved in a multi-vehicle collision event may not find it desirable to pull over and share collision event information. For varied reasons, the driver may not feel as if the environment associated with the collision event is safe. Likewise, the driver may not consider the minor collision serious enough to stop and provide information regarding the collision event.

The present disclosure addresses the above-mentioned issues and more.

### SUMMARY

In one aspect, the present disclosure includes a cloud-based application, hosted on a remote server, for documenting vehicular collision events. The cloud-based application includes a communication module, a collision matching module, and a collision database.

The communication module is in communication with a plurality of vehicles. The collision matching module is operably coupled to the communication module and has a processing unit. The processing unit receives a first collision message reporting a collision event involving a first vehicle. The first collision message includes image data and vehicle data captured by the first vehicle during the collision event. The processing unit also determines whether a second collision message reporting a collision event involving a second vehicle has been received. The second collision message includes image data and vehicle data captured by the second vehicle during the collision event. The processing unit also compare the first collision message with the second collision message for confirming a multi-vehicle collision event involving the first and second vehicles occurred when the second collision message has been received and generates a collision event record to document the multi-vehicle collision event. The collision event record includes a first insurance record for a driver of the first vehicle and a second insurance record for a driver of the second vehicle. The collision database in communication with the collision matching module for storing the first and second collision messages, and the collision event record.

In one form, the processing unit generates a first collision report including the second insurance record for transmitting from the communication module to the first vehicle.

In another form, the processing unit generates a second collision report including the first insurance record for transmitting from the communication module to the second vehicle.

In yet another form, the processing unit (a) generates a list of target vehicles within a predetermined range of the first vehicle, (b) searches the collision database for a target collision message from one of the target vehicles, (c) compares the target collision message with the first collision message, and (d) confirms whether the first vehicle and the second vehicle were involved in a same collision event from the comparison of the target collision message with the first collision message.

In still another form, the vehicle data includes collision metrics and the processing unit prompts a user of the first vehicle, the second vehicle or the first and the second vehicles to confirm whether the first vehicle and the second vehicle were involved in the same collision event, and receives a response from the user confirming that the first and second vehicles were in the same collision event.

In one form, the processing unit generates a first request including a vehicle make, a vehicle model, and a vehicle color of the second vehicle for confirming that the second vehicle was involved in the multi-vehicle collision event. The request is transmitted from the communication module to the first vehicle.

In another form, the processing unit generates a second request including a vehicle make, a vehicle model, and a vehicle color of the first vehicle for confirming that the first vehicle was involved in the multi-vehicle collision event. The request is transmitted from the communication module to the second vehicle.

In yet another form, the first collision message includes vehicle data selected from the group consisting of: a vehicle location, a vehicle make, a vehicle model, a vehicle color, an impact force, an impact direction or a combination thereof for the first vehicle.

In still another form, the processing unit processes the first collision message for confirming that the vehicle location for the second vehicle is within a predetermined distance of the vehicle location for the first vehicle.

In one form, the processing unit processes the first and second collision messages, respectively for confirming that the impact force and impact direction for the second vehicle coincides with the impact force and the impact direction for the first vehicle.

In another aspect, the present disclosure provides a method for documenting vehicular collision events on the cloud-based application hosted on a remote server. The method includes receiving a first collision message from a first vehicle reporting a collision event involving the first vehicle. The first collision message includes image data and vehicle data captured by the first vehicle during the collision event. The method also includes determining whether a second collision message from a second vehicle reporting a collision event involving the second vehicle has been received. The second collision message includes image data and vehicle data captured by the second vehicle during the collision event. The method also includes comparing the first collision message with the second collision message to determine a matched collision event indicating that the first vehicle and the second vehicle were involved in the same collision event when the second collision message has been received, generating a collision event record of the matched collision event. The collision event record includes a first insurance record for a driver of the first vehicle and a second insurance record for a driver of the second vehicle. The method includes storing the first and second collision messages, and the collision event record in a collision database.

In one form, the method includes generating a first collision report including the second insurance record and transmitting the first collision report to the first vehicle.

In another form, the method includes generating a second collision report including the first insurance record and transmitting the second collision report to the second vehicle.

In still another form, the step of receiving the second collision message to report the collision event involving the second vehicle further includes (a) generating a list of target vehicles within a predetermined range of the first vehicle, (b) searching a collision database for a target collision message from one of the target vehicles, (c) comparing the target collision message with the first collision message, and (d) confirming whether the first vehicle and the second vehicle were involved in a same collision event from the comparison of the target collision message and the first collision message.

In yet another form, the vehicle data includes collision metrics and the step (d) further includes (d-1) determining whether a first collision metrics associated with the first collision message coincides with a second collision metrics associated with the target collision message, and (d-2) confirming that the first and second vehicles were involved in the same collision event when the first collision metrics coincides with the second collision metrics.

In one form, the method includes generating a first request including a vehicle make, a vehicle model, and a vehicle color of the second vehicle to confirm that the second vehicle was involved in the multi-vehicle collision event and transmitting the request to the first vehicle.

In some forms, the method includes generating a second request including a vehicle make, a vehicle model, and a vehicle color of the first vehicle to confirm that the first vehicle was involved in the multi-vehicle collision event and transmitting the request to the second vehicle.

In another form, the first collision message includes vehicle data selected from the group consisting of: a vehicle location, a vehicle make, a vehicle model, a vehicle color, an impact force, an impact direction or a combination thereof for the first vehicle.

In still another form, the method includes processing the first and second collision messages, respectively to confirm that the vehicle location for the second vehicle is within a predetermined distance of the vehicle location for the first vehicle.

In yet another aspect, the present disclosure includes a method for documenting vehicular collision events on the cloud-based application hosted on a remote server. The method includes receiving a first collision message from a first vehicle reporting a collision event involving the first vehicle. The first collision message includes image data and vehicle data captured by the first vehicle during the collision event. The method includes storing the first collision message in a collision database, generating a list of target vehicles within a predetermined range of the first vehicle, searching the collision database for a target collision message from one of the target vehicles, comparing the first collision message and the target collision message for the list of target vehicles to confirm that an impact force and an impact direction of the vehicle data associated with the first collision message coincides with an impact force and an impact direction of the vehicle data of one of the target collision messages, confirming whether the first vehicle and the second vehicle were involved in a same collision event from the comparison of the target collision message and the first collision message, and generating a collision event record for the same collision event. The collision event record includes a first insurance record for a driver of the first vehicle and a second insurance record for a driver of the second vehicle.

### BRIEF DESCRIPTION OF THE DRAWINGS

The exemplary embodiments will hereinafter be described in conjunction with the following drawing figures, wherein like numerals denote like elements, and wherein:

FIG. 1 is an illustrative diagram having a collision event sharing (CES) system in accordance with an embodiment;

FIG. 2 is a block diagram of cloud-based collision matching application hosted on a remote server in accordance with an embodiment;

FIG. 3 is a functional flow chart of a method utilizing the collision matching application of FIG. 2 in accordance with an embodiment; and

FIG. 4 is a functional flow chart of a method utilizing the collision matching application of FIG. 2 in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Additional information related to the subject matter described and claimed herein are provided in following related applications which are filed by Applicant of even date herewith: System And Method For Collision Matching And Information Exchange (Attorney Docket No. P108567-PRI-NP-US01); Information Gathering And Sharing From A Collision Event (Attorney Docket No. P108928-PRI-NP-US01); and Cloud-Based Application Platform To Search And Retrieve Evidence Records Related To Vehicular Events (Attorney Docket No. P108926-PRI-NP-US01). The entire disclosures of each of the above applications are incorporated herein by reference.

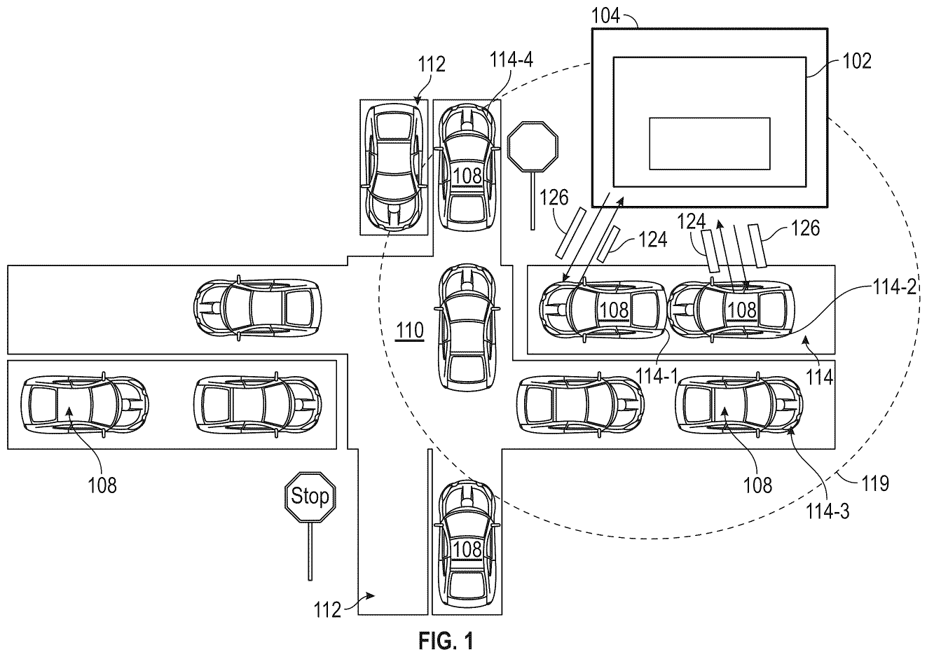

Referring to FIG. 1, the present disclosure provides a collision detection and documenting system 100 that includes a collision matching application 102 stored on a remote server 104 in communication with a user terminal 106 and a plurality of collision reporting devices 108 located about an intersection 110 of a road 112. While the environment of the collision reporting devices 108 is positioned near or about the intersection 110, the environment of the collision reporting devices 108 can include any location where a collision event occurs between a plurality of vehicles 114. The collision reporting device 108 may be embodied in a vehicle, infrastructure (e.g., traffic camera, road sign, light pole, traffic signal, etc.), or a mobile device (e.g., smart phone) of a person in the vicinity of the collision event..

The collision matching application 102 is located geographically remote from the collision reporting devices 108 and functions to receive a plurality of collision messages 124 from the collision reporting devices 108 (e.g., first vehicle 114-1 and second vehicle 114-2), compare the collision messages 124 to confirm a multi-vehicle collision event involving the first and second vehicles 114-1, 114-2 and generate a collision event record 138. The collision matching application 102 may also generate a collision report based on the collision event record 138 for transmission to the first vehicle 114-1, the second vehicle 114-2 or both. The collision message 124 may include image data, geographic data, and/or temporal data. In the case of a vehicle-embodied collision reporting device, the collision message may also include vehicle data related to a respective vehicle at or about a temporal window of a respective collision event. The image data may be still image(s), video image(s) or a combination thereof. The vehicle data may include a collision event, a location data of the vehicle, vehicle make, vehicle model, vehicle color, a vehicle speed, acceleration, collision metrics or a combination thereof. The collision metrics may include steering wheel angle, yaw rate, brake status, air bag deployment, hard braking, stability control, path history, head lights status, vehicle size, turn signal status, an impact direction, and an impact force. The collision message 124 may also include driver license information, vehicle registration information and an insurance policy record, or a combination thereof related to a driver of a respective vehicle transmitting the collision message 124.

Each collision reporting device 108 includes a location system (not shown) such as a global positioning system (GPS), a global navigation system, or a similar satellite navigation system. The location system may be configured to generate location data for the collision reporting device 108, such as via a transceiver communicating with one or more satellites orbiting the Earth. The location data may include a current geographic location of each collision reporting device 108, such as longitude and latitude or GPS coordinates of the collision detection device. Using the current geographic location, each collision reporting device 108 can approximate a location associated with a collision event between the involved vehicles 114-1, 114-2 observed with the respective collision reporting device 108.

Each collision reporting device 108 includes a communication system (not shown) that enables the broadcasting of messages within a predetermined range surrounding a respective collision reporting device 108. Each collision reporting device 108 may transmit or broadcast messages (e.g., data packets containing messages or data) using a dedicated communication protocol, such as a dedicated short-range communication (DSRC), a vehicle-to-vehicle (V2V) communication system, a Cellular Vehicle-to-Everything (C-V2X), Vehicle-to-Infrastructure (V2I), Vehicle-to-People (V2P), 5GLTE cellular communication, or the like. Using this communication broadcast protocol, each collision reporting device 108 is able to transmit at low latency to ensure that messages can be quickly transmitted and received. Each collision reporting device 108 also manages incoming and outgoing data transmission for its respective communication network and may employ asymmetric encryption to secure broadcast messages transmitted or exchanged with the collision matching application 102. Each collision reporting device 108 initiates an input request to a user of a respective vehicle to determine if transmission of a respective collision message 124 is desired. Each collision reporting device 108 determines whether to transmit a collision message 124 when a user preference is set to indicate that transmission of the respective collision message 124 is desired. Each collision reporting device 108 determines not to transmit a collision message 124 based on the user preference being set to indicate that transmission of the respective collision message 124 is not desired.

In one embodiment, the collision reporting devices 108 are registered as a member with the collision matching application 102. As a registered member, each collision reporting device 108 has granted permission to transmit and receive communication messages with the collision matching application 102. Each collision reporting device 108 individually and/or collectively detect a collision event with an unknown vehicle. For example, a first collision reporting device 108-1 may detect a first collision event. The second collision reporting device 108-2 may detect a second collision event. Based on detecting the respective collision events, the first and second collision reporting devices 108-1, 108-2 respectively transmit their respective collision messages to the collision matching application 102. In response to detecting a collision event, the first collision reporting device 108-1 broadcasts a first collision message and the second collision reporting device 108-2 broadcasts a second collision message 124-1, which are received by the collision matching application 102. The first collision message 124-1 and the second collision message 124-2 may also be received by other collision reporting devices 108.

In one example, the collision reporting devices 108 includes the first vehicle 114-1, the second vehicle 114-2, a third vehicle 114-3, a fourth vehicle 114-4 and the like (collectively vehicles 114). For purposes of system 100, the first vehicle 114-1, the second vehicle 114-2, the third vehicle 114-3 and the fourth vehicle 114-4 are similar in structure and function. The first vehicle 114-1 and the second vehicle 114-2, may be collectively referred to as involved vehicles. The vehicles 114 may be conventional, autonomous or semi-autonomous vehicle, respectively in communication with the collision matching application 102. The vehicles 114 may include a motor vehicle such as an automobile, a motorcycle, or a truck a plurality of components and subsystems distributed within the vehicle to work together to perform one or more functions to achieve particular objectives related to the vehicle operation, safety, comfort and/or efficiency. These systems can be mechanical, electrical, electronic, hydraulic or a combination of these are designed to ensure that the vehicle 114 operates and performs effectively under one or more conditions.

In another example, some collision reporting devices 108 may be as a smart phone or similar mobile device (not shown) associated with a person in the vicinity of a collision event. In yet another example, a collision reporting device 108 may be embodied as a stationary device associated with an infrastructure device, such as a traffic camera. Regardless of the embodiment of the device as a mobile device or a stationary device are positioned about an intersection 110 of the road 112 as shown in FIG. 1. Each collision reporting device 108 is configured to acquire data of a collision event between the first vehicle 114-1 and the second vehicle 114-2 and transmit a collision message 124 with the data to the collision matching application 102.

The collision matching application 102 is a cloud-based application that provides a cloud service over a network, such as the Internet or a cellular network. The collision matching application 102 may in hosted by one or more remote servers or computers to process the information exchanged between the involved vehicles 114 and the collision matching application 102 which is remote from the involved vehicles 114.

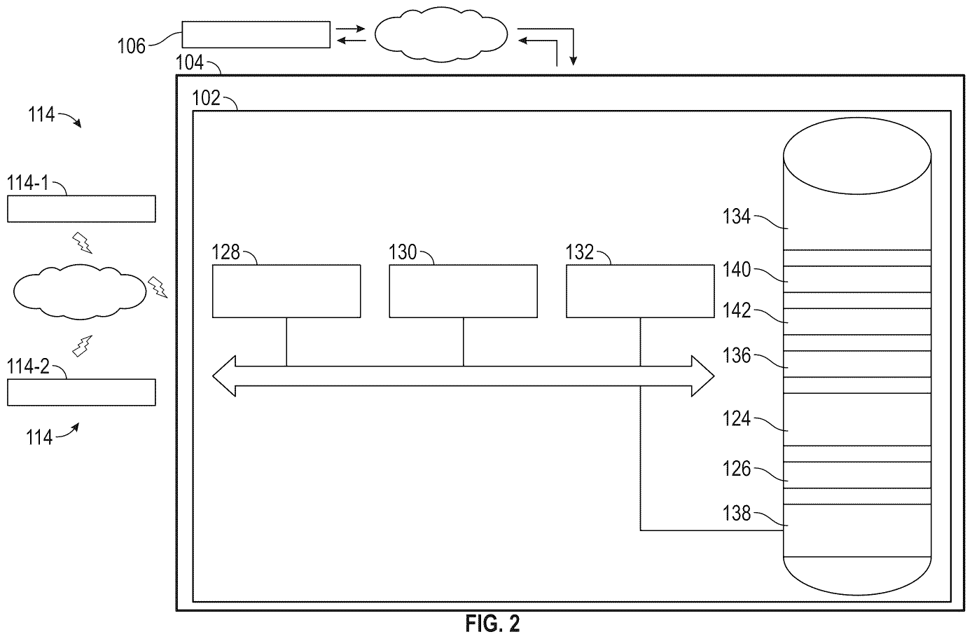

Referring again to FIG. 2, the collision matching application 102 includes a registration module 128, a collision matching module 130, a communication module 132, and a collision database 134. The registration module 128 prompts a user, via a user terminal 106, to enter registration information for associating the collision reporting device 108 with the collision matching application 102. In one embodiment, the collision reporting device is a vehicle. In this embodiment, the registration information includes a user's name, address and mobile number. The registration information may also include a username, vehicle information, an insurance policy record, and driver's license information related to a vehicle and driver being registered. The vehicle information includes data related to the vehicle identification number (VIN), vehicle make, vehicle model, and vehicle color. The insurance policy record includes the identity of the insurance company, the insurance policy number, the insured vehicle and the insured driver(s) under the policy. The driver's license information includes a driver's name, address, license number, and license expiration date. In another embodiment, the collision reporting device 108 may be an infrastructure device. In this embodiment, the registration information includes a device identification number, and a device location; however, there would be no vehicle information, insurance policy record or driver's license information.

The registration module 128 prompts the user to input one or more user preferences to customize a user's experience with the collision matching application 102. The registration module 128 prompts the user, via the user terminal 106, to input a first user preference indicating if the user would like to automatically broadcast a collision message after the collision reporting device 108 detects a collision event. The registration module 128 prompts the user, via the user terminal 106 to input a second user preference indicating whether to notify the user via the user terminal notification to view collision event records identified in a vicinity of the collision reporting device 108. The vicinity of the collision reporting device 108 includes a predetermined range proximate to the collision reporting device 108. The registration module 128 prompts the user, via the user terminal 106, to input a third user preference indicating whether the collision matching application 102 may track the location of the vehicle being registered. Based on the registration information and the user preferences, the registration module 128 creates and stores a user record 136, to the collision database 134, associated for the vehicle being registered.

In one form, if the collision reporting device 108 is a vehicle 114-1, 114-2, 114-3, 114-4, the registration information may include a username, a vehicle information, an insurance policy record, and a driver's license information related to the vehicle 108-1, 108-2, 108-3 being registered. The vehicle information may also include data related to VIN number, vehicle make, vehicle, and vehicle color. The insurance policy record includes an insurance policy name, an insurance policy number, and a name of a driver insurance. The driver's license information includes a driver's name, a driver's address, a driver's license number, and a driver's license expiration date. In another form, if the collision reporting device 108 is the infrastructure device 108-4, the registration information includes a device identification number, and a device location.

The collision matching module 130 receives a request to communicate from a collision reporting device 108, such as an involved vehicle 114. The collision matching module 130 determines if the collision matching module 130 determines if the collision reporting device 108 is a registered member of the collision matching application 102. The collision matching module 130 requests registration of any vehicle requesting communication that is not currently a registered member of the collision matching application 102.

The collision matching module 130 receives a first collision message 124-1 from a first involved vehicle 114-1. The first collision message 124-1 indicates that the first involved vehicle 114-1 has been involved in a first collision event and includes image data and vehicle data captured by the first involved vehicle 114-1 during the first collision event. The collision matching module 130 then collects a list of target vehicles within a predetermined range of the first involved vehicle 114-1 based on the collision reporting devices 108 registered with the collision matching application 102. The collision matching module 130 receives location data from each collision reporting device 108 registered with the registration module 128. Using the location data of the collision reporting devices 108, the collision matching module 130 obtains a list of target vehicles in a vicinity 119 of the involved vehicle 114-1 and determines a total number of target vehicles based on the list of target vehicles obtained. The vicinity 119 of the first involved vehicle 114-1 includes a predetermined range proximate to the first involved vehicle 114-1. The collision matching module 130 determines that vehicles located within the vicinity 119 of the first involved vehicle 114-1. This list of target vehicles is a list of vehicles used to determine if there are any other collision affected or involved vehicles 114 involved in the same collision event with the first involved vehicle 114-1.

The collision matching module 130 identifies a second involved vehicle based on the list of target vehicles. The collision matching module 130 sequentially processes the collision messages 124 for each target vehicle in the list of target vehicles to determine whether the target vehicle is another involved vehicle In this regard, the collision matching module 130 receives and processes a second (or subsequent) collision message from a second (or subsequent) vehicle 114-2. The second collision message 124-2 indicates that the second vehicle has been in a second collision event and would include image data and vehicle data captured by the collision reporting device 108 during the second collision event. The collision matching module 130 stores the second collision message 124-2 in the collision database 134. The collision matching module 130 processes the second collision message to determine a vehicle identification of the second vehicle.

The collision matching module 130 compares the vehicle identification of the second vehicle to the vehicle identification for each of the target vehicles i. The collision matching module 130 determines that one of the target vehicles is the second vehicle when the vehicle identification of the second vehicle matches the vehicle identification of the target vehicle. The collision matching module 130 determines that the target vehicle is not the second vehicle when the vehicle identification of the second vehicle does not match the vehicle identification of the target vehicle. Next, the collision matching module 130 verifies that the target vehicle i is a second involved vehicle 114-2.

In one example, the verification is based on a user query of the user in the involved vehicles. The collision matching module 130 activates a human machine interface (HMI) (not shown) of one or both involved vehicles 114-1, 114-2. The collision matching module 130 displays the first vehicle identification to the user of the second involved vehicle 114-2 and the second vehicle information to a user of the first involved vehicle 114-1 for confirmation that the two vehicles were involved in the same collision event. The collision matching module 130 prompts the user of the respective vehicles, via the HMI, to confirm that the collision matching module 130 has correctly identified the target vehicle as the second involved vehicle 114-2. The collision matching module 130 determines that the target vehicle is the second involved vehicle 114-2 based on a “YES” or “NO” response to the prompt..

In another example, the verification is based information from the first and second collision messages 124-1, 124-2. the collision matching module 130 compares collision metrics from the first collision message 124-1 with collision metrics from the second collision message 124-2. The collision matching module 130 determines whether the first involved vehicle 114-1 and the target vehicle were involved in the same collision event based on matching impact forces and impact directions. The collision matching module 130 obtains a first impact force and a first impact direction from the first collision message 124-1 associated with the first involved vehicle 114-1. The collision matching module 130 also obtains a second impact force and a second impact direction from a respective collision message 124-2 transmitted by the respective target vehicle. The collision matching module 130 determines whether the first impact force and the first impact direction matches the second impact force and the second impact direction, respectively. The collision matching module 130 verifies that the target vehicle is the second involved vehicle when the second impact force and the second impact direction complements the first impact force and the first impact direction. The collision matching module 130 does not confirm the target vehicle i is the second involved vehicle 114-2 when the second impact force and the second impact direction do not complement the second impact force and the second impact direction.

Once the collision matching module 130 verifies that a multi-vehicle collision event involving the first and second vehicles 114-1, 114-2 has occurred, a collision event record 138 is generated by the collision matching module 130 and stored to the collision database 134. The collision event record 138 may include the vehicle registration data, the driver license information, and the insurance policy record extracted from the first and second collision messages 124-1, 124-2. The collision event record may also include image data, vehicle location, car telemetry (e.g., speed, vehicle direction, force applied on brake, force applied on accelerator pedal, air bag status, seatbelt status, advanced driver-assistance system status (e.g., ADAS features enabled/disabled), number of occupants, date and time, and button status for vehicle SAAS application (Software As A Service application) (e.g., Onstar button status is active or inactive).

The collision matching module 130 generates a collision report for the first and second involved vehicles. A first collision report 126-1 includes the vehicle registration data, the driver license information, and/or the insurance policy record related to the driver of the second vehicle 114-2. A second collision report 126-2 includes the vehicle registration data, the driver license information, and/or the insurance policy record related to the driver of the first vehicle 114-1.

Once the collision reports 126-1, 126-2 are generated, the collision matching module 130 determines whether to transmit the first collision report 126-1 to the first vehicle 114-1 and the second collision report to the second vehicle 114-2. In one example, the collision matching module 130 transmits a user response prompt to the first vehicle 114-1 and/or the second vehicle 114-2 to determine if each driver of the involved vehicles 114 desires transmission of the respective collision report. When an affirmative response is received, the collision matching module 130 transmits the first collision report 126-1, 126-2 to the first involved vehicle and the second involved vehicle. In some embodiments, the collision matching module 130 stores the collision reports 126-1, 126-2 in the collision database 134.

The collision database 134 stores data related to registering the collision reporting device 108, and collecting the collision messages 124 sent by the collision reporting device 108, the collision messages 124-1, 124-2, the collision reports 126-1, 126-2 and/or the collision event record 138. The collision database 134 also stores a public key 140, a private key 142, and the user record 136. The public key 140 is used by the collision matching application 102 for securely encrypting the collision reports 126 prior to transmission to respective first vehicle 114-1, the second vehicle 114-2, or a combination thereof. The private key 142 is kept confidential by the collision matching application 102 and is used to decrypt the received collision messages 124 sent from the collision reporting device 108.

The user terminal 106 is a human machine interface that is used by a user to register a specific collision reporting device 108 with the collision matching application 102. The user terminal 106 may include a notebook computer, a desktop computer, a tablet terminal, a personal digital assistant, a smartphone, a wearable device such a glasses-type or wrist-watch-type information processing terminal, or the like. In one example, the user terminal 106 is integrated into a collision reporting device 108. The user terminal 106 transmits data to the collision matching application 102 to register a respective collision reporting device 108. The data is used to register the collision reporting device 108 as a member of the collision matching application 102. As a registered member, the collision reporting device 108 is granted one or more permissions to exchange data communication with the collision matching application 102. The user terminal 106 allows the user to enter data related to one or more user preferences associated with the collision reporting devices 108. The user terminal 106 receives an input, from the user, for a search criterion to request a search and retrieval for the collision report 126. The search criterion includes a search query based on a temporal window associated with the collision event, a location of the collision event, and vehicle description data. The temporal window includes a date and time of associated with the collision event. The vehicle description data includes a vehicle make, a vehicle model, and a vehicle color. The vehicle description may also include a vehicle license plate number.

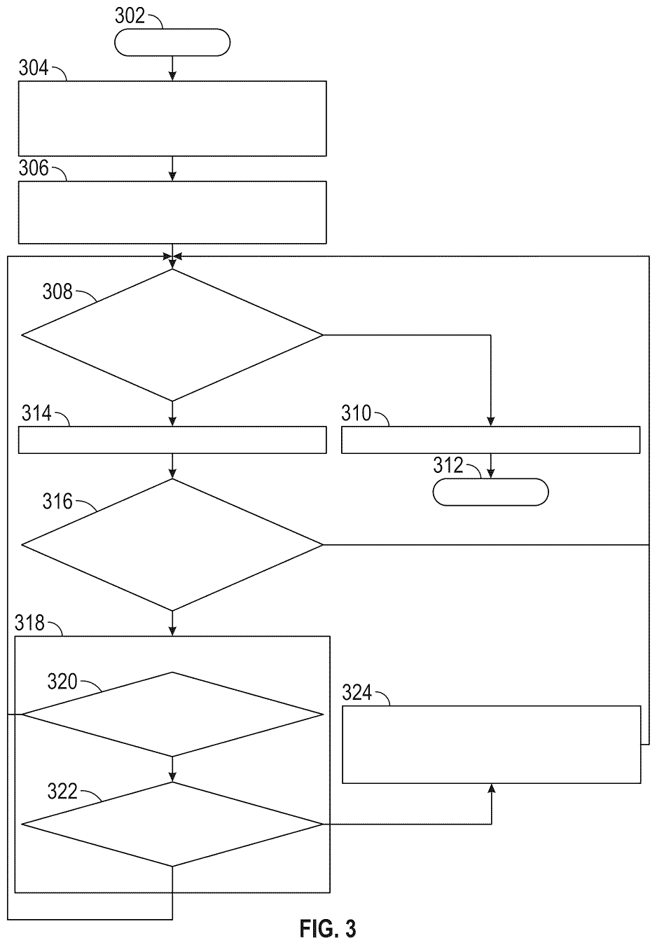

Referring to FIG. 3, the collision matching application 102 utilizes an example method 300 for generating a collision report for involved vehicles 114-1, 114-2 of a multiple vehicle collision event. At step 302, the collision matching application 102 starts the method 300 and proceeds to step 304.

At step 304, the collision matching application 102 receives a first collision message 124 reporting a first collision event from a collision reporting device 108 of a first involved vehicle 114-1 and proceeds to step 306.

At step 306, the collision matching application 102 generates a list of target vehicles within a range of the first involved vehicle 114-1. The list of target vehicles is used to determine other involved vehicles 114 associated with the first collision event. The collision matching application retrieves the location data of each collision reporting device 108 registered within the collision database 134. Using the location data of each of the registered collision reporting device 108, the collision matching application 102 determines whether each collision reporting device 108 is within the predetermined range of the involved vehicle. If a respective collision reporting device 108 is within the predetermined range of the first involved vehicle 114-1, the collision matching application 102 adds the respective collision reporting device 108 to a list of target vehicles. Thus, the list of target vehicles includes involved vehicles 114-2 and uninvolved vehicles 114-3, 114-4 that are withing the vicinity of the first involved vehicle 114-1. Upon compiling the list of target vehicles, the collision matching application 102 calculates a total number of target vehicles and proceeds to step 308.

At step 308, the collision matching application 102 determines whether each vehicle 114,-2, 114-3, 114-4 of the list of target vehicles have been assessed. The collision matching application 102 uses the total number of target vehicles to determine whether all of the target vehicles 114-2, 114-3, 114-4 have been processed. The collision matching application 102 determines whether a target vehicle is the last target vehicle on the list of target vehicles based on the total numbers of target vehicles. If the collision matching application 102 determines “YES” and proceeds to step 310. Otherwise, the collision matching application 102 determines “NO” and proceeds to step 314.

At step 314, the collision matching application 102 obtains a target vehicle i of the list of the target vehicles and proceeds to step 316. Initially i is set to 1 to allow the collision matching application 102 to retrieve a first target vehicle of the list of target vehicles. After the target vehicle i is processed to determine whether it is an involved vehicle, the collision matching application increments i by a predetermined value, such as 1. Incrementing i allows the collision matching application to retrieve a subsequent target vehicle to later processed.

At step 316, the collision matching application 102 determines whether a collision message 124 has been received from the target vehicle i. For example, the collision matching application 102 determines “NO” and returns to step 308. The collision matching application 102 determines “YES” and proceeds to step 318.

At step 318, the collision matching application 102 determines whether the respective target vehicle i is a second involved vehicle 114-2. In determining whether the respective target vehicle i is the second involved vehicle 114-2, the collision matching application 102 proceeds to step 320.

At step 320, the collision matching application 102 determines whether a first impact force associated a collision event of the first involved vehicle 114-1 matches a second impact force associated with a collision event of the respective target vehicle i. The collision matching application 102 obtains the first impact force from the first collision message 124-1 sent by the first involved vehicle 114-1. Likewise, the collision matching application 102 obtains the second impact force from a respective collision message 124-2 sent by the target vehicle i. The collision matching application compares the first impact force to the second impact force to determine whether there is a match of impact forces. If the collision matching application 102 determines “NO” and returns to step 308 to assess the next target vehicle. Otherwise, the collision matching application 102 determines “YES” and proceeds to step 322.

At step 322, the collision matching application 102 determines whether a first impact direction associated with the first collision message 124-1 received from the first involved vehicle 114-1 matches a second impact direction associated with the second collision message 124-2 received to the respective target vehicle i. The collision matching application 102 compares the first impact direction to the second impact direction to determine whether there is a match of impact directions. If the collision matching application 102 determines “NO” and returns to step 308 to assess the next target vehicle. Otherwise, the collision matching application 102 determines “YES, and proceeds to step 3 126 and the target vehicle i becomes a second or another involved vehicle,

At step 324, the collision matching application 102 generates a collision report 126 for the first involved vehicle 114-1 and the second or subsequent involved vehicle 114-2 and proceeds to step 308 to assess the next target vehicle.

Once all target vehicles are assessed, at step 310, the collision matching application 102 transmits generated collision reports to respective involved vehicles 114 and proceeds to END.

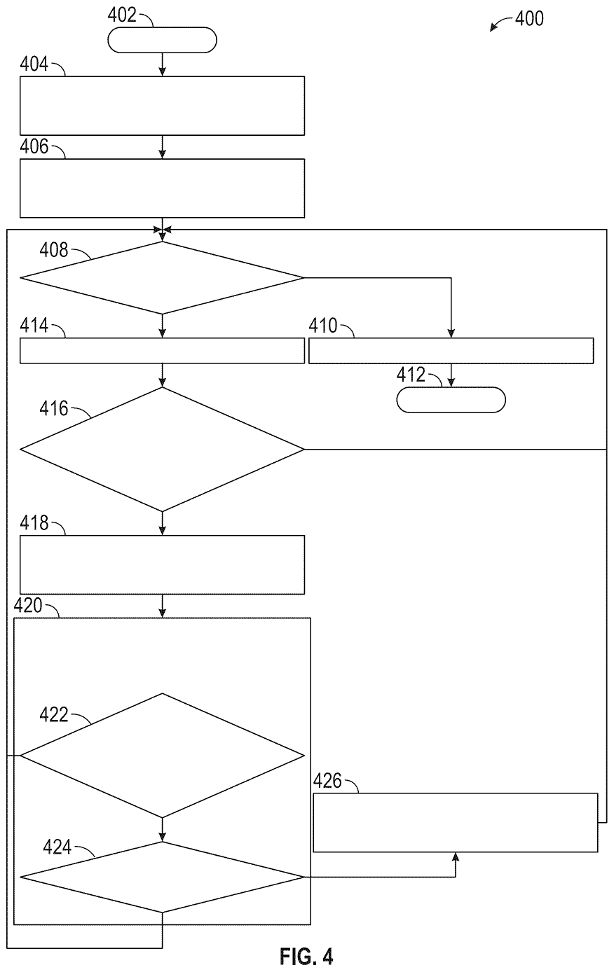

Referring to FIG. 4, the collision matching application 102 utilizes another example method 400 for generating a collision report for involved vehicles of a collision event. At step 402, the collision matching application 102 starts the method 400 and proceeds to step 404.

At step 404, the collision matching application 102 receives a first collision detection message reporting a first collision event from a collision reporting device 108 of a first involved vehicle 114-1, and proceeds to step 406.

At step 406, the collision matching application 102 generates a list of target vehicles within a range of the first involved vehicle 114-1. The list of target vehicles is used to determine other involved vehicles associated with the first collision event. The collision matching application 102 retrieves the location data of each collision reporting device 108 registered within the collision database 134. Using the location data of each of the registered collision reporting device 108, the collision matching application 102 identifies each collision reporting device 108 within the predetermined range of the first involved vehicle 114-1. If a respective collision reporting device 108 associated with a vehicle 114 is within the predetermined range of the first involved vehicle 114-1, the collision matching application 102 adds the respective collision reporting device 108 to the list of target vehicles. Upon completion of assessing each collision reporting device, the collision matching application 102 calculates a total number of target vehicles and proceeds to step 408.

At step 408, the collision matching application 102 determines if all of the target vehicles have been assessed. If the collision matching application 102 determines “YES” and proceeds to step 410. Otherwise, the collision matching application 102 determines “NO” and proceeds to step 414 to assess the next target vehicle.

At step 414, the collision matching application 102 gets a target vehicle of the list of the target vehicles and proceeds to step 416.

At step 416, the collision matching application 102 determines whether a collision detection message has been received from a target vehicle. If the collision matching application 102 determines “NO,” the method returns to step 408 to see if all target vehicle have been assessed. Otherwise, the collision matching application 102 determines “YES” and proceeds to step 418. At step 418, the collision matching application 102 activates the HMI of the target vehicle and proceeds to step 420.

At step 420, the collision matching application 102 determines whether the target vehicle was involved in a collision event the first involved vehicle, and therefore is the second involved vehicle 114-2. In determining whether the target vehicle is the second involved vehicle, the collision matching application 102 proceeds to step 422.

At step 422, the collision matching application 102 prompts the user, via the HMI, of the target vehicle to confirm whether his or her vehicle was involved in a collision event with the first involved vehicle. The collision matching application 102 retrieves the image data associated with the first collision message received from the first involved vehicle 114-1. The collision matching application 102 displays the image data to the user associated with the target vehicle and prompts the user to confirm whether the target vehicle is involved in the collision event. If the response from the user is “NO,” the collision matching application 102 determines returns to step 408. If, the response from the user is “YES,” the collision matching application 102 verifies the target vehicle as a second (or subsequent) involved vehicle proceeds to step 424.

At step 424, the collision matching application determines whether a user of the first involved vehicle 114-1 or the second or subsequent involved vehicle 114-2 desires to exchange driver, vehicle and insurance information. If the collision matching application 102 determines “NO,” the method 400 returns to step 408 to see if all target vehicles have been assessed. If the collision matching application 102 determines “YES, the method 400 proceeds to step 426.

At step 426, the collision matching application 102 generates a collision report for the first involved vehicle 114-1 and the second (or subsequent) involved vehicle 114-2 and proceeds to step 408 to see if all target vehicles have been assessed.

Once all target vehicles have been assessed, the method 400 proceeds to step 410 and the collision matching application 102 transmits collision reports generated at step 426 to respective involved vehicles 114 and proceeds to END at step 412.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A cloud-based application, hosted on a remote server, for documenting vehicular collision events, the cloud-based application comprising:
a communication module configured to communicate with a plurality of vehicles;
a collision matching module operably coupled to the communication module and having a processing unit configured to:
receive a first collision message reporting a collision event involving a first vehicle, wherein the first collision message includes image data and vehicle data captured by the first vehicle during the collision event;
determine whether a second collision message reporting a collision event involving a second vehicle has been received, wherein the second collision message includes image data and vehicle data captured by the second vehicle during the collision event;
compare the first collision message with the second collision message for confirming a multi-vehicle collision event involving the first and second vehicles occurred when the second collision message has been received; and
generate a collision event record to document the multi-vehicle collision event, wherein the collision event record includes a first insurance record for a driver of the first vehicle and a second insurance record for a driver of the second vehicle; and
a collision database in communication with the collision matching module for storing the first and second collision messages, and the collision event record.

2. The cloud-based application of claim 1, wherein the processing unit is further configured to generate a first collision report including the second insurance record for transmitting from the communication module to the first vehicle.

3. The cloud-based application of claim 2, wherein the processing unit is further configured to generate a second collision report including the first insurance record for transmitting from the communication module to the second vehicle.

4. The cloud-based application of claim 1, wherein the processing unit is further configured to:
(a) generate a list of target vehicles within a predetermined range of the first vehicle;
(b) search the collision database for a target collision message from one of the target vehicles;
(c) compare the target collision message with the first collision message; and
(d) confirm whether the first vehicle and the second vehicle were involved in a same collision event from the comparison of the target collision message with the first collision message.

5. The cloud-based application of claim 4, wherein the vehicle data includes collision metrics and the processing unit is further configured to:
prompt a user of the first vehicle, the second vehicle or the first and the second vehicles to confirm whether the first vehicle and the second vehicle were involved in the same collision event; and
receive a response from the user confirming that the first and second vehicles were in the same collision event.

6. The cloud-based application according to claim 1, wherein the processing unit is further configured to generate a first request including a vehicle make, a vehicle model, and a vehicle color of the second vehicle for confirming that the second vehicle was involved in the multi-vehicle collision event, wherein the request is transmitted from the communication module to the first vehicle.

7. The cloud-based application according to claim 6, wherein the processing unit is further configured to generate a second request including a vehicle make, a vehicle model, and a vehicle color of the first vehicle for confirming that the first vehicle was involved in the multi-vehicle collision event, wherein the request is transmitted from the communication module to the second vehicle.

8. The cloud-based application according claim 1, wherein the first collision message comprises vehicle data selected from the group consisting of: a vehicle location, a vehicle make, a vehicle model, a vehicle color, an impact force, an impact direction or a combination thereof for the first vehicle.

9. The cloud-based application according claim 8, wherein the processing unit is further configured to process the first collision message for confirming that the vehicle location for the second vehicle is within a predetermined distance of the vehicle location for the first vehicle.

10. The cloud-based application according claim 8, wherein the processing unit is further configured to process the first and second collision messages, respectively for confirming that the impact force and impact direction for the second vehicle coincides with the impact force and the impact direction for the first vehicle.

11. A method for documenting vehicular collision events on the cloud-based application hosted on a remote server, the method comprising:
receiving a first collision message from a first vehicle reporting a collision event involving the first vehicle, wherein the first collision message includes image data and vehicle data captured by the first vehicle during the collision event;
determining whether a second collision message from a second vehicle reporting a collision event involving the second vehicle has been received, wherein the second collision message includes image data and vehicle data captured by the second vehicle during the collision event;
comparing the first collision message with the second collision message to determine a matched collision event indicating that the first vehicle and the second vehicle were involved in the same collision event when the second collision message has been received;
generating a collision event record of the matched collision event, wherein the collision event record includes a first insurance record for a driver of the first vehicle and a second insurance record for a driver of the second vehicle; and
storing the first and second collision messages, and the collision event record in a collision database.

12. The method of claim 11, further comprising generating a first collision report including the second insurance record and transmitting the first collision report to the first vehicle.

13. The method of claim 12, further comprising generating a second collision report including the first insurance record and transmitting the second collision report to the second vehicle.

14. The method of claim 13, wherein the receiving a second collision message reporting a collision event involving a second vehicle further comprises:
(a) generating a list of target vehicles within a predetermined range of the first vehicle;
(b) searching a collision database for a target collision message from one of the target vehicles;
(c) comparing the target collision message with the first collision message; and
(d) confirming whether the first vehicle and the second vehicle were involved in a same collision event from the comparison of the target collision message and the first collision message.

15. The cloud-based application of claim 4, wherein the vehicle data includes collision metrics and the step (d) further comprises:
(d-1) determining whether a first collision metrics associated with the first collision message coincides with a second collision metrics associated with the target collision message; and
(d-2) confirming that the first and second vehicles were involved in the same collision event when the first collision metrics coincides with the second collision metrics.

16. The method according to claim 11, further comprising generating a first request including a vehicle make, a vehicle model, and a vehicle color of the second vehicle to confirm that the second vehicle was involved in the multi-vehicle collision event and transmitting the request to the first vehicle.

17. The method according to claim 16, further comprising generating a second request including a vehicle make, a vehicle model, and a vehicle color of the first vehicle to confirm that the first vehicle was involved in the multi-vehicle collision event and transmitting the request to the second vehicle.

18. The method according claim 11, wherein the first collision message comprises vehicle data selected from the group consisting of: a vehicle location, a vehicle make, a vehicle model, a vehicle color, an impact force, an impact direction or a combination thereof for the first vehicle.

19. The method according claim 18, further comprising processing the first and second collision messages, respectively to confirm that the vehicle location for the second vehicle is within a predetermined distance of the vehicle location for the first vehicle.

20. A method for documenting vehicular collision events on the cloud-based application hosted on a remote server, the method comprising:
receiving a first collision message from a first vehicle reporting a collision event involving the first vehicle, wherein the first collision message includes image data and vehicle data captured by the first vehicle during the collision event;
storing the first collision message in a collision database;
generating a list of target vehicles within a predetermined range of the first vehicle;
searching the collision database for a target collision message from one of the target vehicles;
comparing the first collision message and the target collision message for the list of target vehicles to confirm that an impact force and an impact direction of the vehicle data associated with the first collision message coincides with an impact force and an impact direction of the vehicle data of one of the target collision messages;
confirming whether the first vehicle and the second vehicle were involved in a same collision event from the comparison of the target collision message and the first collision message; and
generating a collision event record for the same collision event, wherein the collision event record includes a first insurance record for a driver of the first vehicle and a second insurance record for a driver of the second vehicle.
